(19) United States
(12) Patent Application Publication
(10) Pub. No.: US 2011/0095508 A1
(43) Pub. Date: Apr. 28, 2011

(54) QUICK-RELEASE MECHANISM FOR WHEEL CHAIR AND AUXILIARY OPERATING LEVER

(75) Inventor: Chien-Liang CHIU, Taipei (TW)

(73) Assignee: WU'S TECH Co., Ltd., Hsinchu City (TW)

(21) Appl. No.: 12/605,912

(22) Filed: Oct. 26, 2009

(51) Int. Cl. A61G 5/10

(52) U.S. Cl. 280/304.1

(57) ABSTRACT

The present invention provides a quick-release mechanism for the wheelchair and auxiliary operating lever. The quick-release mechanism includes a pivoting seat of the operating lever, limiting rabbet and snapping rod. The pivoting seat of operating lever is provided with convex lug, and the limiting rabbet with mouthed profile is arranged at the front of the convex lug. The limiting rabbet forms a guide opening and a bracing flange. The guide opening is extended in an outward-dipping state. A snapping rod is arranged transversely onto the operating lever. The present invention allows to save the components and realize rapid removal and assembly with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a quick-release mechanism, and more particularly to an innovative mechanism, which allows an auxiliary operating lever to be assembled onto a manually-operated wheel chair for easy and quick removal and assembly purpose.

2. Description of Related Art Including Information Disclosed Under 37 CFR 1.97 and 37 CFR 1.98.

The wheelchairs are generally used for disabled people, who must push them manually by themselves or be pushed by others with much burdens or efforts.

For this reason, an auxiliary power structure that can be mounted onto existing manual wheelchairs has been developed, enabling the manual wheelchairs to move autonomously. In detail, when the manual wheelchairs are used by the disabled, the motor onboard the auxiliary power structure can drive the wheelchairs, thus eliminating the bothersome manual pushing and also making it convenient. In addition, the users can also control manually the moving direction of the wheelchairs for simple and convenient operation.

However, the auxiliary power structure for existing wheelchairs is mainly provided with a handle and a motor. The handle is assembled onto the front side of the wheelchair, and the motor is used for electric drive, thus turning the wheelchair into a self-controlled walking mechanism and allowing the users to control the rotating direction via the handle.

Nevertheless, the typical manual wheelchairs along with the handles still face the shortcomings, such as imperfect design, excessive components and improper/time-consuming assembly. Hence, there is still a room for further improvement.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, the quick-release mechanism is mainly composed of a pivoting seat of operating lever, limiting rabbet and snapping rod. The limiting rabbet of the present invention is provided with guide opening and bracing flange in an outward-dipping state. The snapping rod of the operating lever can be inserted into or disengaged from the limiting rabbet, and positioned securely or removed flexibly via the locking portion, thereby saving the components and realizing rapid removal and assembly with improved applicability.

There are improvements brought about by this invention.

As the pivoting seat of operating lever comprises a mating seat of vertical rod, a rotary adjusting seat and a height adjusting seat. The mating seat of the vertical rod and the rotary adjusting seat, or the rotary adjusting seat and the height adjusting seat are provided with bolt holes aligned at different locations, and mated via bolts, so that the limiting rabbet of the convex lug can be rotatably shifted and adjusted in tune with the carriage of the wheelchair.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows an assembled perspective view of the preferred embodiment of the present invention.

FIG. 3 shows an exploded perspective view of the auxiliary operating lever along with the mounting rack and the wheelchair of the present invention.

FIG. 4 shows an exploded perspective view of the pivoting seat of operating lever of the present invention.

FIG. 5 shows an enlarged perspective view of FIG. 3.

FIG. 6 shows an operating elevation view of the preferred embodiment of the present invention.

FIG. 7 shows another operating elevation view of the preferred embodiment of the present invention.

### DETAILED DESCRIPTION OF THE INVENTION

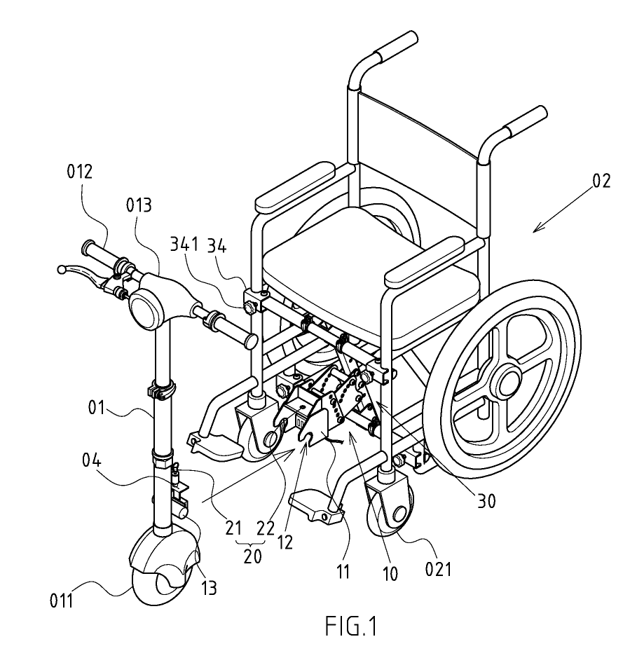

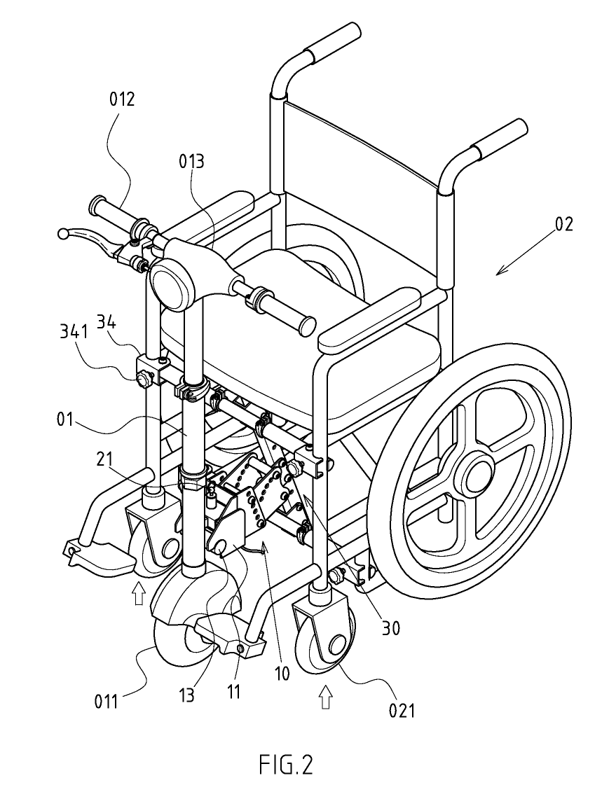

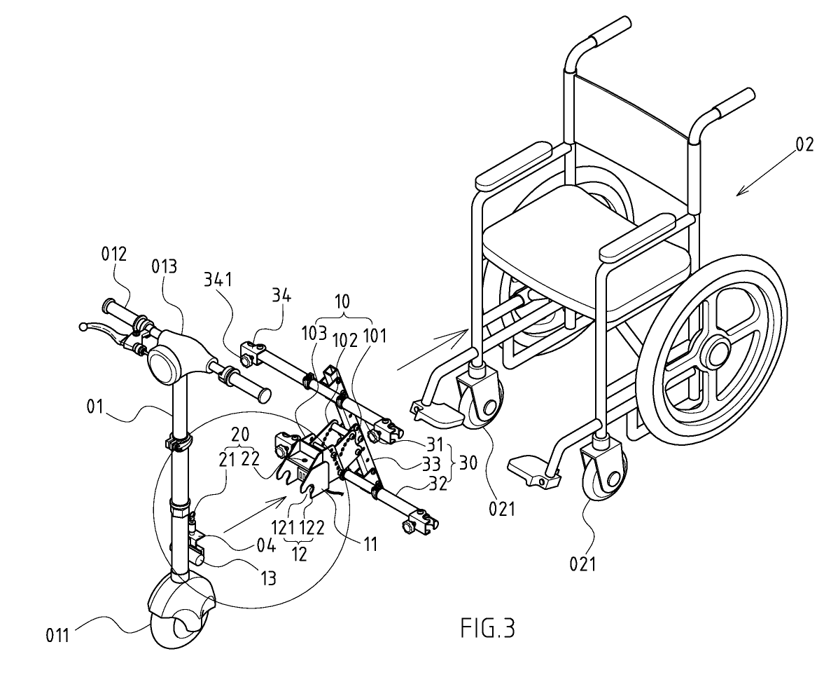

FIGS. 1-3 depict preferred embodiments of a quick-release mechanism for the wheelchair and auxiliary operating lever of the present invention. The embodiments are provided for only explanatory objective for patent claims.

The auxiliary operating lever 01 can be mounted onto existing manual wheelchair 02, turning it into a self-controlled walking mechanism. A mounting rack 30 is erected at the front side of the carriage of the wheelchair 02, so that the auxiliary operating lever 01 can be mounted onto the carriage via a quick-release mechanism, and a drive unit is used to drive the wheelchair 02. An auxiliary steering wheel 011 is placed at the bottom of the auxiliary operating lever 01, and a control pedestal 013 with a cross handle 012 arranged at the top.

The quick-release mechanism comprises a pivoting seat of operating lever 10, which is assembled onto the mounting rack 30. The pivoting seat of operating lever 10 is provided with convex lug 11.

The present invention includes a limiting rabbet 12 with a mouthed profile. The limiting rabbet 12 is arranged in front of the convex lug 11 of the pivoting seat of operating lever 10. The limiting rabbet 12 forms a guide opening 121 and a bracing flange 122. The guide opening 121 is extended in an outward-dipping state.

The present invention also includes a snapping rod 13, which is arranged transversely onto the operating lever 01.

Thus, the snapping rod 13 of the operating lever 01 is obliquely embedded upwards into the limiting rabbet 12 of the pivoting seat of operating lever 10, and then mated securely with the limiting rabbet 12 via a locking portion 20. With this embedding state, the mounting rack 30 drives the front wheel 021 of the wheelchair 02 to be lifted off, so as to rotate easily the direction of the wheelchair 02.

The locking portion 20 is composed of a pulling rod 21 and a spacing hole 22. The pulling rod 21 is arranged onto a spacer 04 on the periphery of the operating lever 01, and the pulling rod 21 can be pulled vertically. The spacing hole 22 is arranged onto the pivoting seat of operating lever 10. The pulling rod 21 can be locked into, or disengaged from the spacing hole 22, so as to control the positioning or disengagement of the operating lever 01.

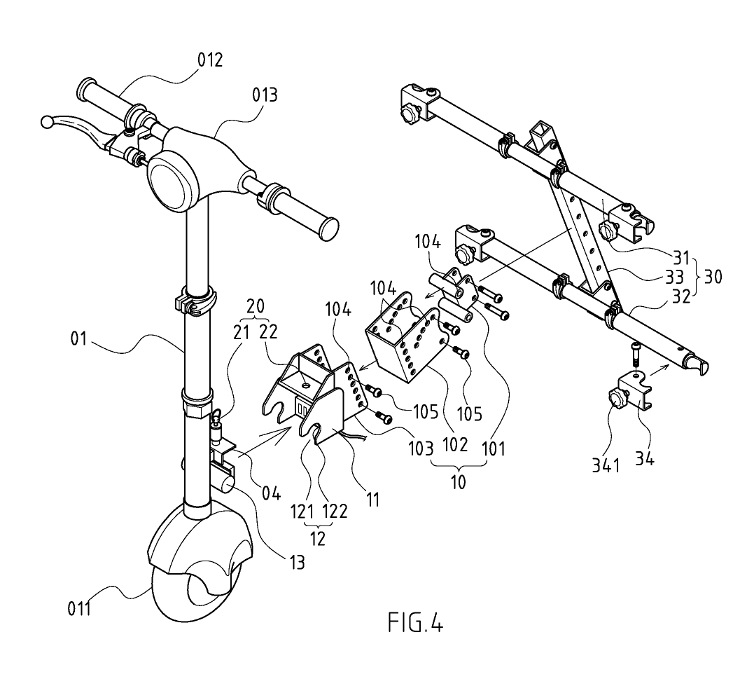

Referring to FIG. 4, the mounting rack 30 consists of an upper cross rod 31, a lower cross rod 32 and a vertical rod 33. The upper and lower cross rods 31, 32 are configured vertically at interval, and both ends of the vertical rod 33 are separately linked to the upper and lower cross rods 31, 32, so that the vertical rod 33 can be assembled between the upper and lower cross rods 31, 32. The left and right ends of the upper and lower cross rods 31, 32 are assembled onto the front rack of the carriage via the locator 34 with a fastening bolt 341. The pivoting seat of operating lever 10 is mounted onto the vertical rod 33 of the mounting rack 30.

Referring to FIG. 4, the pivoting seat of operating lever 10 comprises a mating seat of vertical rod 101, a rotary adjusting seat 102 and a height adjusting seat 103. The mating seat of vertical rod 101 and the rotary adjusting seat 102, or the rotary adjusting seat 102 and the height adjusting seat 103 are provided with bolt holes aligned at different locations, and mated via bolts 105. The convex lug 11 is arranged at both sides of the height adjusting seat 103, so that the limiting rabbet 12 of the convex lug 11 can be rotatably shifted and adjusted in tune with the carriage of the wheelchair 02.

Based upon above-specified structure, the present invention is operated as follows:

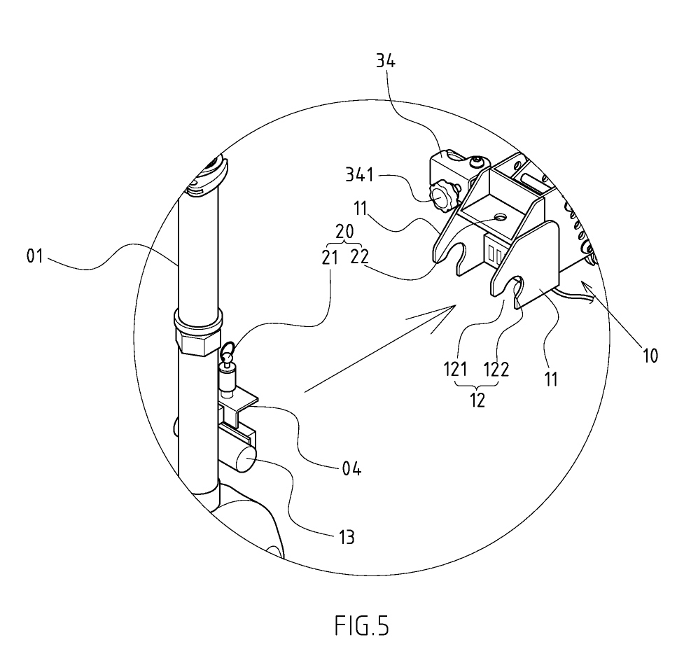

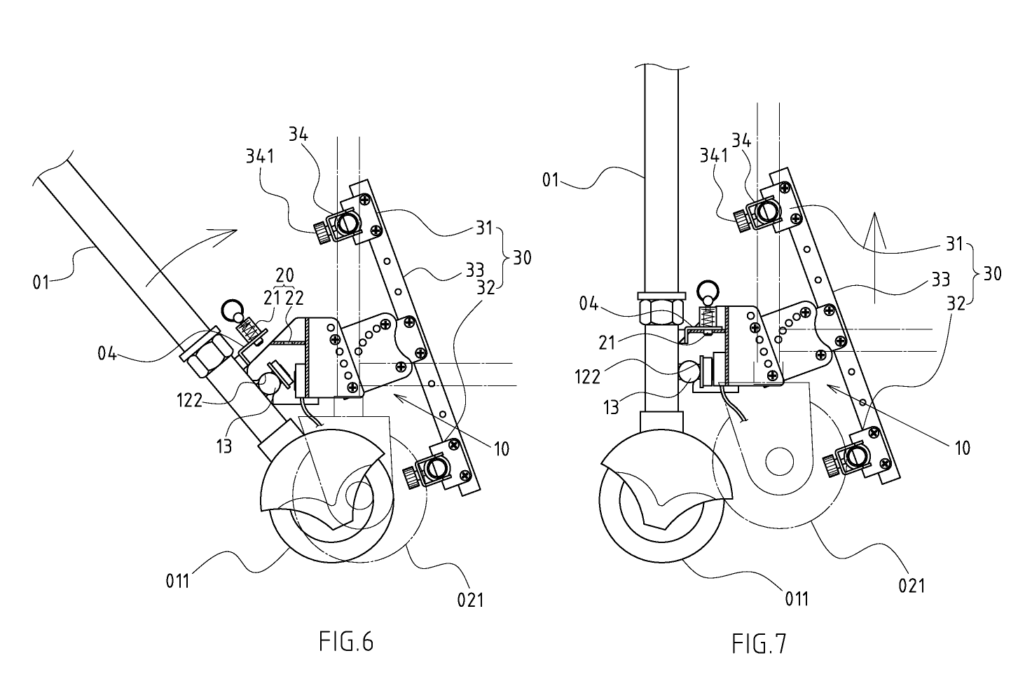

Referring to FIGS. 5 and 6, the limiting rabbet 12 is extended in an outward-dipping state, the snapping rod 13 of the operating lever 01 is obliquely embedded upwards into the limiting rabbet 12 from the guide opening 121 of the limiting rabbet 12, and a blocking effect is generated by the bracing flange 122 of the limiting rabbet 12. When the snapping rod 13 is embedded into the limiting rabbet 12, the pulling rod 21 of the locking portion 20 is inserted into the spacing hole 22, enabling stable and secure embedding of the snapping rod 13 of the operating lever 01.

Referring also to FIG. 7, when the snapping rod 13 is embedded into the limiting rabbet 12, the operating lever 01 obliquely shifts upwards so that the pivoting seat of operating lever 10 is coupled with the mounting rack 30, while the front wheel 021 of the wheelchair 02 is driven for lifting off, permitting users to rotate easily the direction of the wheelchair 02 through the auxiliary steering wheel 011 and the rear wheel of the wheelchair. On the other hand, the lift-off front wheel 021 can be used to prevent tilting of the wheelchair 02.

When the auxiliary operating lever 01 is under an idle state, the pulling rod 21 of the locking portion 20 can be disengaged from the spacing hole 22. In such a case, the snapping rod 13 embedded into limiting rabbet 12 can be removed from the limiting rabbet 12 to separate the snapping rod 13 from the pivoting seat of operating lever 10. So, the auxiliary operating lever 01 can be easily removed from the front side of the wheelchair 02, realizing easy removal and assembly purpose.

1. A quick-release mechanism for a wheelchair and auxiliary operating lever, wherein the auxiliary operating lever mounts onto an existing manual wheelchair so as to be a self-controlled walking mechanism, wherein a mounting rack is erected at a front side of a carriage of the wheelchair, so that the auxiliary operating lever mounts onto the carriage via a quick-release mechanism, and wherein a drive unit is used to drive the wheelchair, said quick-release mechanism comprises:
a pivoting seat of the operating lever, being assembled onto the mounting rack and being provided with a convex lug;
a limiting rabbet with a mouthed profile, being arranged in front of the convex lug and forming a guide opening and a bracing flange, said guide opening is extended in an outward-dipping state; and
a snapping rod, being arranged transversely onto the operating lever and obliquely embedded upwards into the limiting rabbet, said snapping rod being mated securely with the limiting rabbet via a locking portion.

2. The quick-release mechanism defined in claim 1, wherein the locking portion is comprised of a pulling rod and a spacing hole; wherein the pulling rod is arranged onto a spacer on a periphery of the operating lever, and wherein the pulling rod is pulled vertically, said spacing hole being arranged onto the pivoting seat of operating lever, said pulling rod being locked into, or disengaged from the spacing hole.

3. The quick-release mechanism defined in claim 1, wherein the mounting rack is comprised of an upper cross rod, a lower cross rod and a vertical rod; wherein the upper and lower cross rods are configured vertically at intervals, and both ends of the vertical rod are separately linked to the upper and lower cross rods, so that the vertical rod are assembled between the upper and lower cross rods; and wherein the left and right ends of the upper and lower cross rods are assembled onto the front rack of the carriage via the locator with a fastening bolt, the pivoting seat of operating lever being mounted onto the vertical rod of the mounting rack.

4. The quick-release mechanism defined in claim 1, wherein the pivoting seat of the operating lever comprises a mating seat of a vertical rod, a rotary adjusting seat and a height adjusting seat; wherein the mating seat of vertical rod and the rotary adjusting seat, or the rotary adjusting seat and the height adjusting seat are provided with bolt holes aligned at different locations, and mated via bolts; and wherein the convex lug is arranged at both sides of the height adjusting seat, so that the limiting rabbet of the convex lug is rotatably shifted and adjusted.
